(19) United States
(12) Patent Application Publication
(10) Pub. No.: US 2002/0078217 A1
(43) Pub. Date: Jun. 20, 2002

(54) Online alcoholic beverage license verification system

(76) Inventors: Jonathan Thomas, San Clemente, CA (US); Neal Weisman, Santa Ana, CA (US); William Egan III, Laguna Beach, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 09/916,803

(22) Filed: Jul. 27, 2001

Related U.S. Application Data
(60) Provisional application No. 60/221,572, filed on Jul. 28, 2000.

(51) Int. Cl. G06F 15/16; G06F 17/30

(52) U.S. Cl. 709/230; 707/3

(57) ABSTRACT

A method for verifying information comprises collecting information to be verified from a plurality of different sources wherein at least two of the sources provide information in formats which differ from one another, modifying the collected information to conform to a common format, storing the modified information in a common data base, and providing the stored information.

### PRIORITY CLAIM

This Patent Application claims the benefit of the filing date of provisional patent application serial No. 60/221,572, filed Jul. 28, 2000 and entitled ONLINE ALCOHOLIC BEVERAGE LICENSE VERIFICATION SYSTEM, the entire contents of which are hereby expressly incorporated by reference.

### FIELD OF THE INVENTION

The present invention relates generally to computer network systems. The present invention relates more particularly to a method for verifying information, such as the validity of an alcoholic beverage license.

### BACKGROUND OF THE INVENTION

In the United States any person, company, or other entity involved in the manufacture, distributing, or sales of alcoholic beverages must have a valid license to do so. Typically, a licensed manufacturer, supplier, importer or broker sells alcoholic beverages to a licensed distributor, who then distributes these products to licensed retailers. The licensing system was established after prohibition in order to help control the sales of alcohol and to ensure that the applicable taxes are paid.

However, a longstanding problem is the verification of the validity of an alcoholic beverage license. This problem is most evident in the sales of alcohol to retailers by distributors. It is the distributor's responsibility to verify that the retailer to whom the distributor is selling alcohol has a valid alcoholic beverage license. However, in order to verify the validity of a retailer's alcoholic beverage license, the distributor must typically be present personally at an Alcoholic Beverage Control office and pay a fee to the Alcoholic Beverage Control office. This contemporary method for verifying the validity of a retailer's alcoholic beverage license, particularly when it is considered that the distributor must verify the licenses of a large number of such retailers, is prohibitive both as to the cost associated therewith and the time expended. Moreover, this procedure is so onerous as to be overlooked on many occasions. However, when a distributor fails to verify the validity of a retailer's alcoholic beverage license, that distributor's license is itself then in jeopardy due to the legal and administrative ramifications of potentially selling to an unlicensed retailer.

In an attempt to solve this problem of alcoholic beverage license verification, systems have been developed wherein a distributor can pay a fee for the periodic (such as weekly) distribution of a list of all of the valid alcoholic beverage licenses in a particular state. However, the system does not provide real-time alcoholic beverage license verification. That is, in some instances the list may contain inaccurate information, such as information that a particular retailer's alcoholic beverage license is valid when that particular retailer's alcoholic beverage license is not valid. Thus, the distributor runs the risk of selling, albeit inadvertently, to an unlicensed retailer.

Further, such periodically distributed lists are typically received in hard-copy form. Therefore, a distributor must check each retailer's listing individually in order to determine whether that particular retailer's alcoholic beverage license is valid. Therefore, this system of periodic distribution of alcoholic beverage license status information is, in addition to being non real-time, again costly and time consuming.

In view of the foregoing, it is desirable to provide a system for verifying information, such as alcoholic beverage license status, which is real-time in nature, which is comparatively inexpensive, and which is not undesirably time consuming.

### SUMMARY OF THE INVENTION

The present invention specifically addresses and alleviates the above-mentioned deficiencies associated with the prior art. More particularly, the present invention comprises a method for verifying information, such as the validity of an alcoholic beverage license, wherein the method comprises collecting information to be verified from a plurality of different sources, at least two of the sources providing the information in formats which differ from one another; modifying the collected information to conform to a common format; storing the information in a common database; and providing the information.

These, as well as other advantages of the present invention, will be more apparent from the following description and drawings. It is understood that changes in the specific structure shown and described may be made within the scope of the claim without departing from the spirit of the invention.

### BRIEF DESCRIPTION OF THE DRAWINGS

These and other features, aspects, and advantages of the present invention will be more fully understood when considered with respect to the following detailed description, appended claims and accompanying drawings, wherein:

FIG. 1 is a flow chart outlining the collection of information, with modification and combination of that information;

FIG. 2 is a flow chart showing the User log in process;

FIG. 3(a) is a flow chart outlining the first part of an information verification request and/or search as being performed by a User.

FIG. 3(b) is a flow chart continuing FIG. 3(a) and shows the completion of the information verification request and/or search being performed by a User.

FIG. 4(a) is a flow chart outlining the first part of a ‘batch’ information verification request and/or search as being performed by a User.

FIG. 4(b) is a flow chart continuing FIG. 3(b) and shows the completion of the ‘batch’ information verification request and/or search being performed by a User.

FIG. 5 is an excel spreadsheet outlining (as but one specific example of many) the existence of defined data sub-entities (States) w/differing data formats (.doc, .xls, etc.) of similar information with still differing license classifications (Types). Asynchronous updating periods are also illustrated.

FIG. 6 is a block diagram showing the first memory for storing the input data in different formats, the first processor for determining which conversion algorithm to use, the second processor for implementing the selected conversion algorithm, and the second memory for storing the data in a common format.

FIG. 7 is a block diagram showing the first memory, second memory, first processor and second processor of FIG. 6, wherein the first and second memories are defined by a common memory.

FIG. 8 is a block diagram showing the common database for storing the information in a common format, a network (the Internet) for facilitating dissemination of the information, and the client distributors querying the common database via the Internet and receiving responses which verify the validity of the alcoholic beverage licenses of either individual retailers or of lists of retailers.

### DETAILED DESCRIPTION OF THE INVENTION

The detailed description set forth below in connection with the appended drawings is intended as a description of the presently preferred embodiment of the invention, and is not intended to represent the only form in which the present invention may be constructed or utilized. The detailed description sets forth the construction and functions of the invention, as well as the sequence of steps for operating the invention in connection with the illustrated embodiment. It is to be understood, however, that the same or equivalent functions may be accomplished by different embodiments that are also intended to be encompassed within the spirit and scope of the invention.

The present invention comprises a software program which facilitates querying of the alcoholic beverage license status (or similar information), preferably within a selected state. The system can be implemented for any or all states, such that a distributor having multi-state sales can easily and efficiently verify the status of the alcoholic beverage licenses for retailers in each state where the distributor does business. Preferably, the present invention facilitates query by license number, license address, business name, licensee name, pending applications and interim permits, recently issued licenses, inactive licenses, suspended licenses, special events and by an advance search function. The advance search function allows distributors to input, update and query all of their customers in a single bulk query, so as to facilitate simplification and efficiency of use.

According to one aspect of the present invention, license database information is seamlessly integrated with the accounting system of users, such as distributors, so as to allow the users to automatically accept or deny orders entered into the accounting system. That is, a distributor, for example, merely enters an order into the distributor's order entry or other accounting system and that system then autonomously (without substantial further input from the operator) verifies the validity of the alcoholic beverage license of the recipient of the order and then either authorizes or denies the order based upon this information.

More particularly, the present invention comprises a method for verifying information, the method comprising collecting information to be verified from a plurality of different sources, at least two of the sources providing the information in formats which differ from one another. The collected information is modified so as to conform to a common, desired format. The information, after being modified to conform to the common format, is stored, preferably in a common database. Alternatively, the database may be segregated in any desired manner. Stored information relating to the verification of the validity of an alcoholic beverage license is provided when a query is made, either by a person or automatically, such as via an accounting system. The information facilitates verification of the validity of an alcoholic beverage license, for example.

Collecting information preferably comprises collecting information from a plurality of different sources. For example, information may be collected from a federal government agency, a state government agency, a city government agency, individual retailers, other distributors, or any other desired source.

Modifying the information preferably comprises using an application which automatically conforms the format of the information to a common, single desirable format which is suitable for storage in a common database. Alternatively, the information may be stored in a plurality of different databases. The information may also, alternatively, be stored in a plurality of different formats.

Modifying the information preferably comprises using a first application to select which one of a plurality of second applications to use to conform the information to the common format. The first application preferably bases the selection of which of the plurality of second applications to use upon a format of the collective information. The selected second application is preferably configured to modify the format of the collective information, so as to conform to the common format.

Providing the stored information preferably comprises providing the stored information via a network, such as the Internet. Optionally, the stored information may be provided via a virtual private network, via a dedicated connection, or via a leased telephone line. Those skilled in the art will appreciate the various other means for providing the information are likewise suitable. For example, the information may be faxed, provided as a telephone message, or provided via any other desired method.

The information may be displayed, such as via a Web browser or via an executable program.

The present invention further comprises requesting verification of the information, such as requesting verification of a single unit of information. For example, a single unit of information may comprise verification of whether or not a particular retailer's alcoholic beverage license is presently valid. Alternatively, verification of a plurality of units of information, such as whether a list of retailers' alcoholic beverage licenses are valid.

Thus, the present invention comprises a method for verifying the validity of an alcoholic beverage license, wherein the method comprises collecting information regarding the validity of alcoholic beverage licenses within a plurality of different jurisdictions, modifying the collected information such that the collected information conforms to a common format, storing the modified information into a common database, and providing the modified information to users, such as via a network.

A system for verifying information, such as alcoholic beverage licenses, comprises a first memory for storing information from a plurality of different sources, a first processor for determining the format of the information, a second processor for modifying the format of at least some of the information so as to conform the formats of all of the information to a common format, and a second memory for storing the modified information according to the common format. The first and second memory is optionally defined by a common memory. The first and second processors optionally comprise a common processor.

The system preferably further comprises a network connection for facilitating communication of the information. Optionally, the system further comprises at least one dedicated communications connection for facilitating communication of the information.

With particular reference to the drawings, the method for verifying information is discussed in detail below.

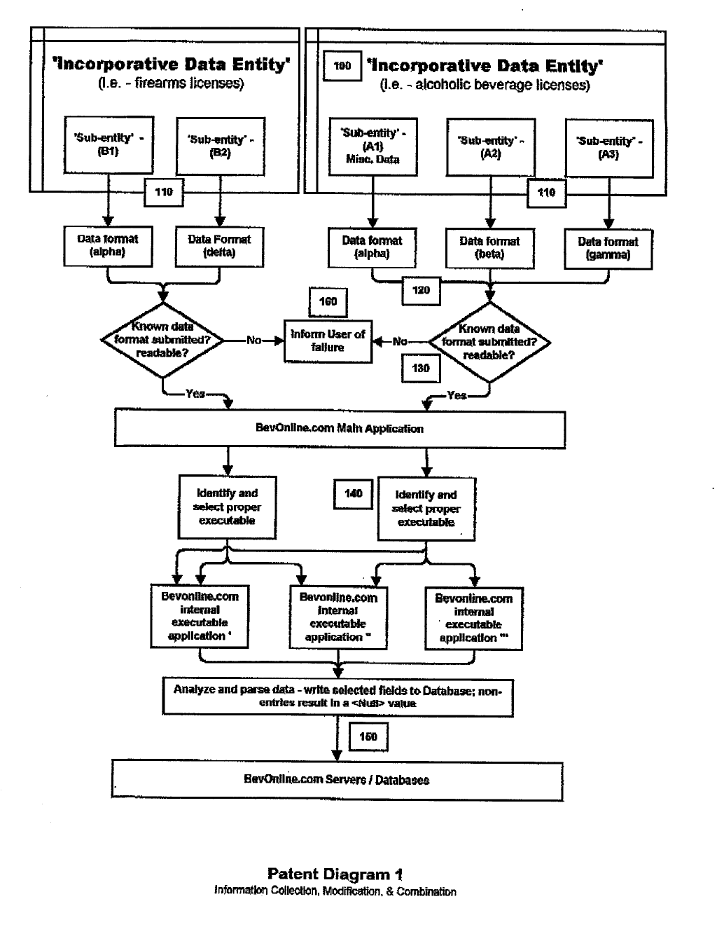

Referring now to FIG. 1, information collection and modification is shown wherein:

Block 100—The ‘Incorporative Data Entity’ (IDE) is the top level data entity that includes major or large markets (such as Alcohol beverage distributors, firearm manufacturers, retailers, Immigration officials) that have a legitimate business need for an invention that enables the verification of information; particularly, when the information is of a heterogeneous, but still overwhelmingly similar, nature, relative to the specified market or industry.

Block 110—The IDE ‘sub-entity’ consists of sub-sections that the Incorporative Data Entity may be further broken down into . . . (i.e. Geographic regions, States, Towns, other jurisdictions, etc..) (These entities themselves are usually relatively static sub-sets of information; however, they may need to amended periodically.)

Block 120—In this example, Four different data formats (alpha, beta, gamma, delta) are being sent by 5 different sub-entities, within 2 different IDE's.

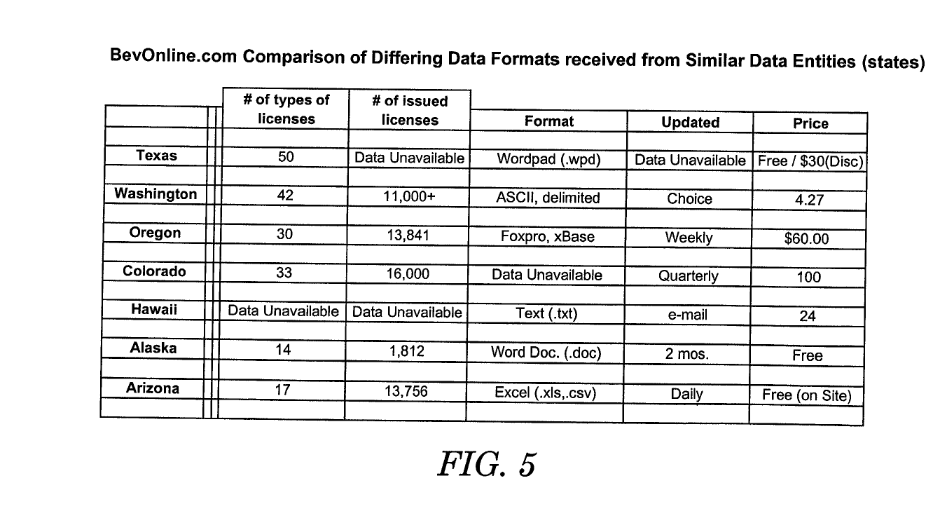

Block 130—Are the format data formats being sent ‘known’ and ‘accepted’ in the system. (These would include, but are not limited to: see Attached FIG. 5)

Yes, Forward to Block 140

No, Forward to Block 160

Block 140—The BevOnline.com Main Application, after analyzing the respective document formats; identifies and selects the proper executable.

Block 150—The BevOnline.com internal executable application analyzes and parses data from known document formats. The executable then writes the data into the corresponding data fields into the Master Database. (Non-entries in some data fields will result in a <NULL> value, due to the fact that not all data fields within a respective IDE and/or data sub-entity will match exactly—this is to be expected. This is but one problem that the present invention helps to overcome.)

Block 160—User is informed of failure to analyze given data format.

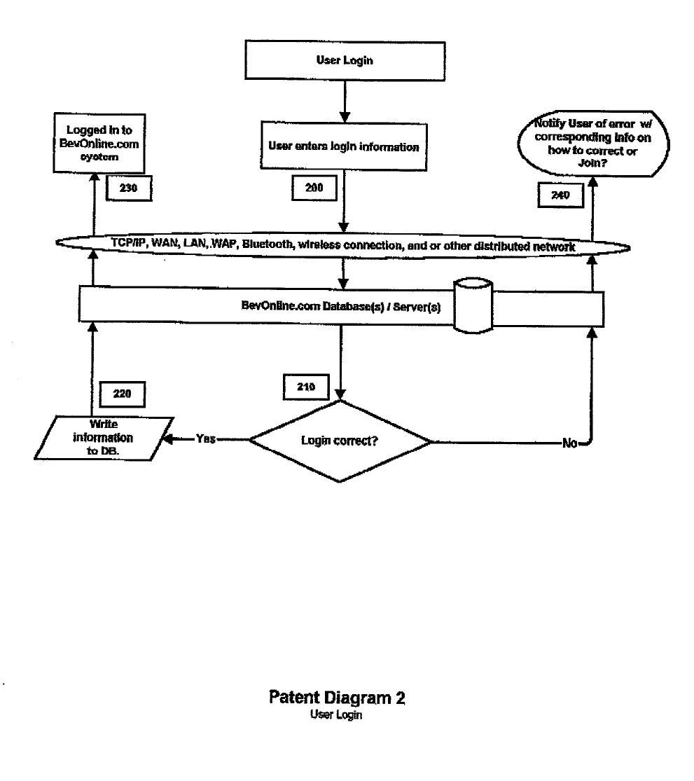

Referring now to FIG. 2, user login is shown, wherein:

Block 200—User logs on to system. User fills in personal and payment mechanism (i.e. Credit Card, Debit Card) information (if applicable) as identified by BevOnline.com or a licensed affiliated partner.

Users may login to BevOnline.com servers via a web site or stand-alone software application, a PDA, any wireless network connectivity device, etc. Users may also login via a licensed partner's ‘co-branded’ web site and/or ‘co-branded’ BevOnline application software.

Block 210—Login Correct?

Yes; Forward to Block 220

No; Forward to Block 240

Block 220—Write personal, location-specific (if applicable), and/or other business/field-specific information to a BevOnline.com (or affiliated partner's) database. Log user into system.

Block 230—User is logged into System

Block 240—Notify User of error in signup information and corresponding help on how to correct.

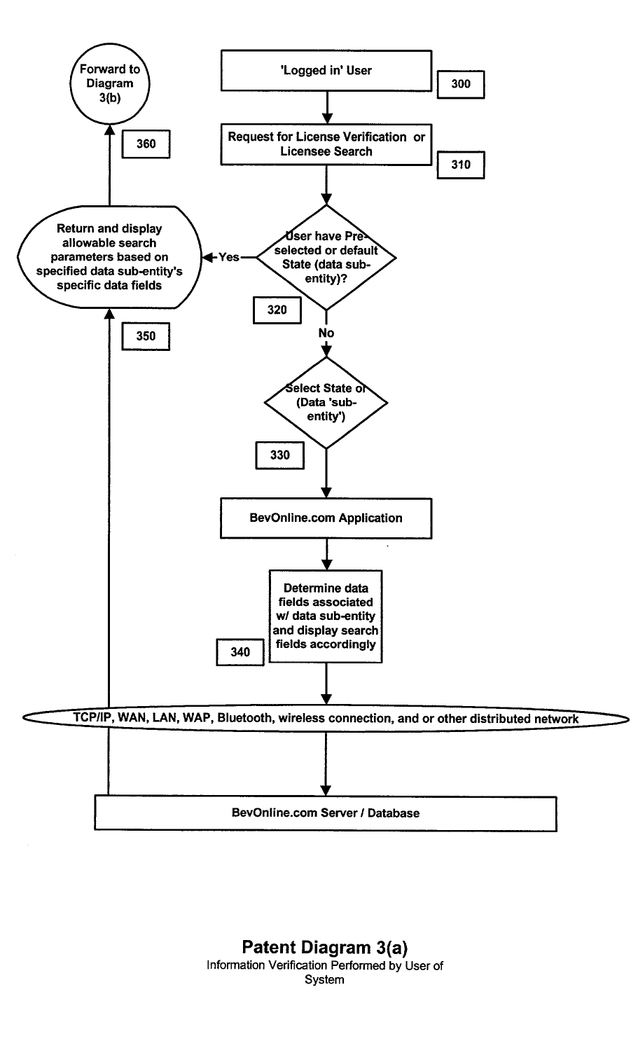

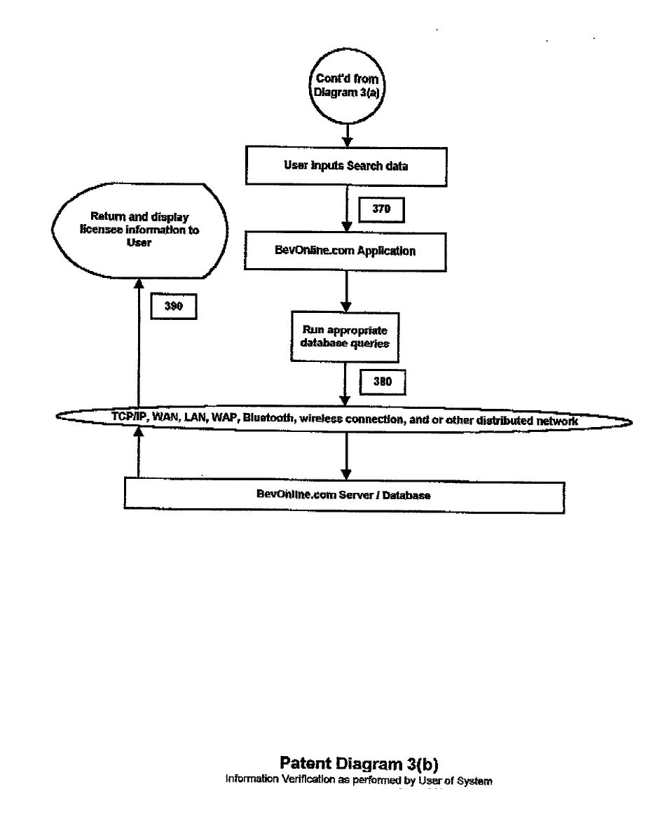

Referring now to FIG. 3a, information verification performed by the user of the system is shown, wherein:

Block 300—User/Alcohol Beverage Distributor/Immigration official/Firearms retailer, etc.. ‘logged in’ to system. (Typically via a TCP/IP connection, but not limited to.)

Block 310—User makes request for License verification and/or Licensee information search.

Block 320—Has user already chosen a State or data sub-entity as a default?

Yes, Forward to Block 350

No, Forward to Block 330

Block 330—User must select data sub-entity or equivalent. (Specific State, Region, etc.)

Block 340—The BevOnline.com application will determine data fields associated with selected sub-entity and correlate with database.

Block 350—User receives display containing and outlining allowable verification/search parameters as determined in Block 340.

Block 360—Forward to Diagram 3(b), Block 370

Block 370—User inputs verification/search data into application.

Block 380—BevOnline.com application will run the appropriate database queries to ‘mine’ data and find desired information.

Block 390—User is displayed all pertinent and requested licensee verification/search information.

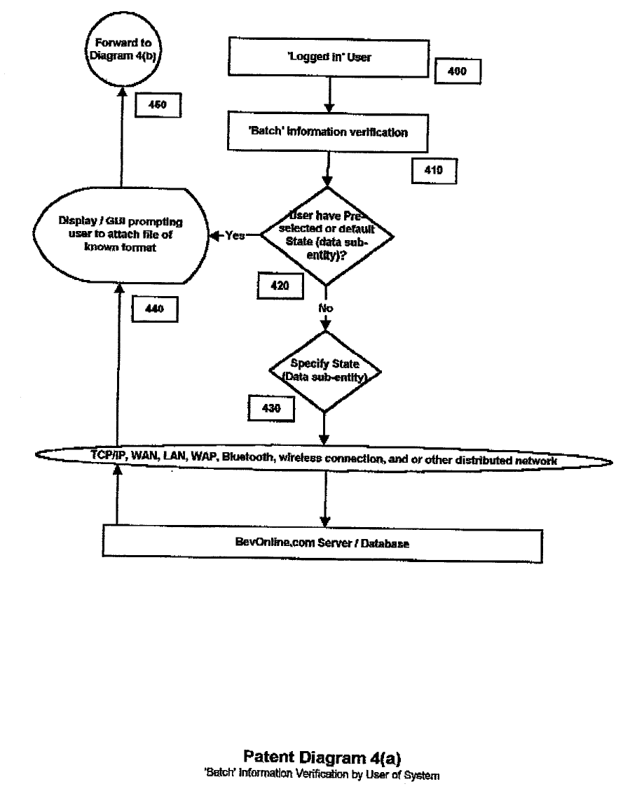

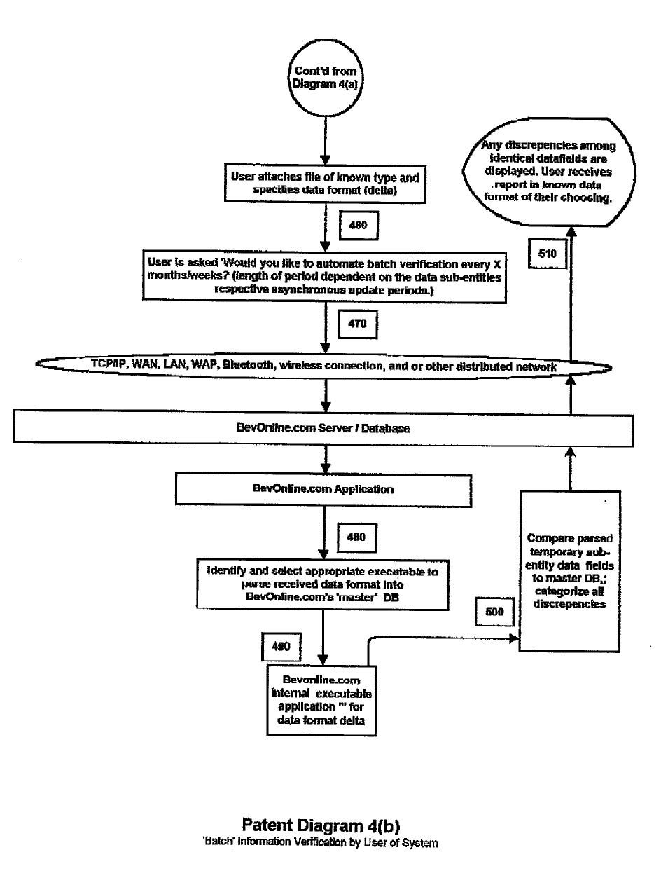

Referring now to FIG. 4, ‘batch’ information verification by user of system is shown, wherein:

Block 400—User/Alcohol Beverage Distributor/Immigration official/Firearms retailer, etc. ‘logged in’ to system. (Typically via a TCP/IP connection, but not limited to.)

Block 410—User makes request for Batch License verification and/or Batch Licensee information search.

Block 420—Has user already chosen a State or data sub-entity as a default selection?

Yes, Forward to Block 440

No, Forward to Block 430

Block 430—User must select data sub-entity or equivalent. (Specific State, Region, etc.)

Block 440—User is given a display or GUI, prompting user to attach file of known and, in all best practices, in the same or similar data format w/same or similar data fields to user's specified sub-entity. (Can be in differing formats from sub-entity—but, in all practicality should not be.)

Block 450—Forward to Diagram 4(b), Block 460

Block 460—User attaches file of known and specifies data format ‘delta.’

Block 470—User is asked if they would like to automate their batch verification process for every X weeks/months. (Length of time period between automated batch verifications is dependent on the sub-entities updating frequency. BevOnline.com system recognizes and records asynchronous update periods of differing sub-entities so as to dynamically enable user to choose to update timely, knowledgeably, and efficiently.

Block 480, Block 490—BevOnline.com server and application will identify and select the appropriate executable for received data format so as to parse received data format temporarily into BevOnline.com ‘master’ database—for ease of comparison of data.

Block 500—Compare parsed temporary sub-entity data fields to master DB,; categorize all discrepancies.

Block 510—Any discrepancies among data fields are displayed. User receives custom report in known data format of their choosing.

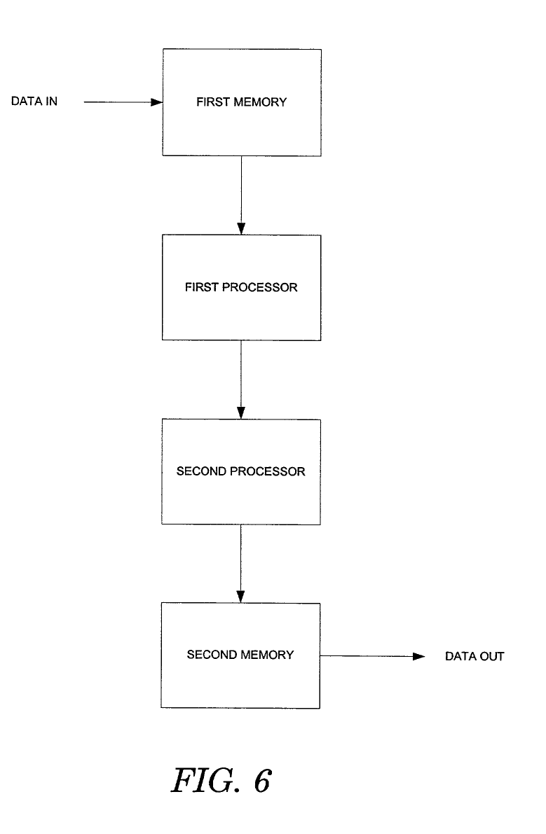

FIG. 6 is a block diagram showing use of the first memory, first processor, second processor, and second memory to transform data into a common format. As shown, data is provided to the first memory. This data may comprise data in a variety of different formats. The first processor analyzes at least a portion of the data so as to determine the format thereof. The first processor then determines which, from among a plurality of different algorithms, is used so as to transform the data into the desired common format. The second processor then executes the selected algorithms so as to transform the data into the desired common format. The transformed data is then stored in the second memory. Data may be read out of the second memory so as to facilitate response to queries, such as by distributors.

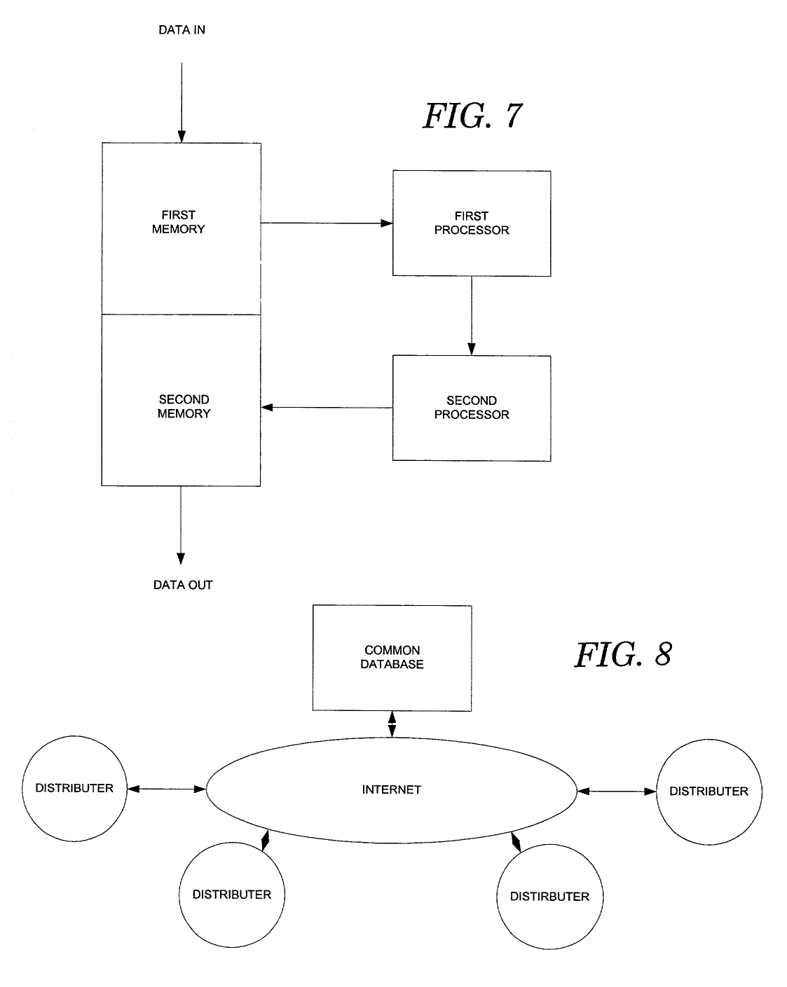

Referring now to FIG. 7, optionally, the first and second memory may be defined by a common memory, such as ram, a hard disk, or any other desired type of memory. Similarly, the first and second processor may comprise a single processor. Indeed, the first and second memory may comprise the memory of a personal computer and the first and second processor may comprise the CPU of a personal computer, such that the selection of the algorithms for conforming the data to a common format and the execution of the algorithm for conforming the data to a common format are all performed on a personal computer.

Referring now to FIG. 8, the common database is made accessible to a network, such as the Internet. Distributors can then query the common database via the Internet and receive responses to their queries via the Internet, such that the distributors may easily and efficiently verify information, such as the validity of alcoholic beverage licenses.

Thus, according to the present invention, a comparatively low cost, easy to use, and time efficient method and system are provided for verifying information, such as the validity of alcoholic beverage licenses.

It is understood that the exemplary on-line alcoholic beverage license verification system described herein and shown in the drawings represents only a presently preferred embodiment of the invention. Indeed, the various modifications and additions may be made to such embodiment without departing from the spirit and scope of the invention. For example, the present invention may be implemented on a wide variety of different types of computers, servers, networks and other electronic or optical processing and communications systems. Further, the present invention may be utilized for the verification of various different types of information, such as driver's license information, fire arms license information, medical license information and bar membership. Thus, these and other modifications and additions may be obvious to those skilled in the art and may be implemented to adapt the present invention for a variety of different applications.

What is claimed is:

1. A method for verifying information, the method comprising:
collecting information to be verified from a plurality of different sources, at least two of the sources providing the information in formats which differ from one another;
modifying the collected information to conform to a common format;
storing the modified information in a common database; and
providing the stored information.

2. The method as recited in claim 1, wherein the information facilitates verification of the validity of an alcoholic beverage license.

3. The method as recited in claim 1, wherein the step of collecting information comprises collecting information from a plurality of different sources.

4. The method as recited in claim 1, wherein the step of collecting information comprises collecting information from a plurality of different sources within at least one of:
a federal government agency;
a state government agency; and
a city government agency.

5. The method as recited in claim 1, wherein modifying the information comprises using an application to conform a format of the information to a single format suitable for a common database.

6. The method as recited in claim 1, wherein modifying the information comprises using a first application to select which one of a plurality of second applications to use to conform the information to a common format.

7. The method as recited in claim 1, wherein modifying the information comprises using a first application to select which one of a plurality of second applications to use to conform the information to a common format, the first application basing the selection of which one of the plurality of second applications to use upon a format of the collected information and the selected second application being configured to modify the format of the collected information so as to conform to the common format.

8. The method as recited in claim 1, wherein providing the stored information comprises providing the stored information via a network.

9. The method as recited in claim 1, wherein providing the stored information comprises providing the stored information via the Internet.

10. The method as recited in claim 1, wherein providing the stored information comprises providing the stored information via a virtual private network.

11. The method as recited in claim 1, wherein providing the stored information comprises providing the stored information via a dedicated connection.

12. The method as recited in claim 1, wherein providing the stored information comprises providing the stored information via a leased telephone line.

13. The method as recited in claim 1, further comprising displaying the provided information.

14. The method as recited in claim 1, further comprising displaying the provided information via a web browser.

15. The method as recited in claim 1, further comprising displaying the provided information via an executable program.

16. The method as recited in claim 1, further comprising requesting verification of the information.

17. The method as recited in claim 1, further comprising requesting verification of a single unit of information.

18. The method as recited in claim 1, further comprising requesting verification of a plurality of units of information according to a bulk processing procedure.

19. A method for verifying the validity of an alcoholic beverage license, the method comprising:
collecting information regarding validity of alcoholic beverage licenses with a plurality of different jurisdictions;
modifying the collected information to conform to a common format; storing the modified information in a common database; and
providing the modified information via a network.

20. A system for verifying information, the system comprising:
a first memory for storing information from a plurality of different sources;
a first processor for determining the format of the information;
a second processor for modifying the format of at least some of the information so as to conform the formats of all of the information to a common format; and
a second memory for storing the modified information according to the common format.

21. The system as recited in claim 20, further comprising a network connection for facilitating communication of the information.

22. The system as recited in claim 20, further comprising at least one dedicated communications connection for facilitating communication of the information.
